(19) United States
(12) Patent Application Publication
(10) Pub. No.: US 2022/0184807 A1
(43) Pub. Date: Jun. 16, 2022

(54) HUMANOID GAIT CONTROL METHOD, DEVICE AND STORAGE MEDIUM OF HUMANOID ROBOTS

(71) Applicant: UBTECH ROBOTICS CORP LTD, Shenzhen (CN)

(72) Inventors: Jie Bai, Shenzhen (CN); Chunyu Chen, Shenzhen (IN); Ligang Ge, Shenzhen (CN); Yizhang Liu, Shenzhen (CN); Youjun Xiong, Shenzhen (CN)

(21) Appl. No.: 17/137,431

(22) Filed: Dec. 30, 2020

Related U.S. Application Data
(63) Continuation of application No. PCT/CN2020/136864, filed on Dec. 16, 2020.

(51) Int. Cl. B25J 9/16

(52) U.S. Cl. CPC B25J 9/1664; B25J 9/162

(57) ABSTRACT

The present disclosure provides a humanoid gait control method, device, apparatus and storage medium of humanoid robots. The method includes: obtaining a first vector from a virtual centroid to an ankle joint of a left leg of the humanoid robot at a current moment and a second vector from the virtual centroid to an ankle joint of a right leg at the current moment, and obtaining an original planning value of the virtual centroid of the current moment of the humanoid robot; determining a height of the target virtual centroid of the humanoid robot after the virtual centroid is reduced at the current moment according to the first vector, the second vector, the original planning value of the virtual centroid and a preset virtual centroid height reduction algorithm; and controlling the humanoid robot to walk on straight knees according to the height of the target virtual centroid.

### CROSS REFERENCE TO RELATED APPLICATIONS

The present application is a continuation-application of International Application PCT/CN2020/136864, with an international filing date of Dec. 16, 2020, the contents of all of which are hereby incorporated by reference.

### BACKGROUND

### 1. Technical Field

The present disclosure relates to robot control technology, and particularly to a humanoid gait control method, device, and storage medium of humanoid robots.

### 2. Description of Related Art

Current researches on biped robots have solved the problem of robot walking pattern, and a variety of humanoid robots have achieved stable walking gait patterns. However, the walking mode of these traditional humanoid robots is not as natural as that of humans. The main reason is that the robot's knee joint control in the robot walking mode is different from the human walking mode. The human walking mode includes walking with straight knees, and the similar. Nevertheless, there is no such walking mode for the humanoid robots.

The reason resides in that the straight knee posture is actually a kinematic singular point, where the inverse motion cannot be solved. Therefore, in order to prevent the singularity from occurring, it is necessary to preset the minimum knee flexion value to perform knee flexion walking so as to avoid the generation of singularities. This makes the steering gear moment of the knee joint of the traditional robot require a larger torque. As a result, the hardware design is heavier, and the gait area is different from the human gait. At the same time, the walking speed cannot be further increased.

### BRIEF DESCRIPTION OF THE DRAWINGS

To describe the technical schemes in the embodiments of the present disclosure or in the prior art more clearly, the following briefly introduces the drawings required for the descriptions in the present disclosure. It should be understood that, the drawings in the following description merely show some embodiments of the present disclosure. For those skilled in the art, other drawings can be obtained according to the drawings without creative efforts.

FIG. 1 is a flowchart of a humanoid gait control method of humanoid robots in accordance with one embodiment of the present disclosure.

FIG. 2 is a schematic view of the right leg of the humanoid robot in accordance with one embodiment of the present disclosure.

FIG. 3 is a schematic view of the right leg of the humanoid robot in accordance with another embodiment of the present disclosure.

FIG. 4 is a schematic view of the walking mode of the humanoid robot in accordance with one embodiment of the present disclosure.

FIG. 5 is a schematic view of a comparison between the height change of the centroid in the embodiment of the present disclosure and the traditional LIMP centroid;

FIG. 6 is a schematic view showing the gait cycle division of the humanoid gait control method of the humanoid robots in accordance with one embodiment of the present disclosure.

FIG. 7 is a schematic view of the pitch angle of the foot of the humanoid robot changing with the preset coefficient in accordance with one embodiment of the present disclosure.

FIG. 8 is a schematic view of the foot parameters of the humanoid gait control method of humanoid robots in accordance with one embodiment of the present disclosure.

FIG. 9 is a schematic view illustrating the relationship between the ankle position changes caused by changes in the pitch angle of the soles of the swinging legs of the humanoid gait control method of humanoid robots in accordance with one embodiment of the present disclosure.

FIG. 10 is a schematic view illustrating the change of ankle position in X direction of the humanoid gait control method of humanoid robots in accordance with one embodiment of the present disclosure.

FIG. 11 is a schematic view illustrating the amount of change in the ankle position in the Z direction of the humanoid gait control method of humanoid robots in accordance with one embodiment of the present disclosure.

FIG. 12 is a schematic view showing the computing device in accordance with one embodiment of the present disclosure.

### DETAILED DESCRIPTION

In order to make the objects, features and advantages of the present disclosure more obvious and easy to understand, the technical solutions of the present disclosure will be further described below with reference to the drawings and the embodiments. Apparently, the described embodiments are part of the embodiments of the present disclosure, not all of the embodiments. All other embodiments obtained by those skilled in the art based on the embodiments of the present disclosure without creative efforts are within the scope of the present disclosure.

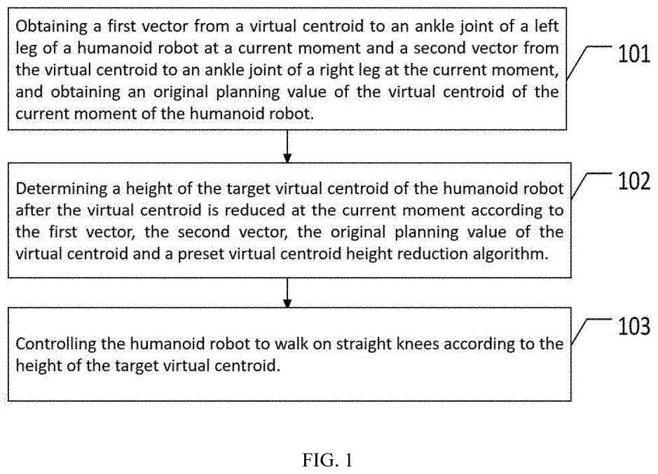

FIG. 1 is a flowchart of a humanoid gait control method of humanoid robots in accordance with one embodiment of the present disclosure. Referring to FIG. 1, the method includes:

In step 101: obtaining a first vector from a virtual centroid to an ankle joint of a left leg of a humanoid robot at a current moment and a second vector from the virtual centroid to an ankle joint of a right leg at the current moment, and obtaining an original planning value of the virtual centroid of the current moment of the humanoid robot.

In the embodiment, the humanoid robot having two robotic legs, which can be called a left leg and a right leg, imitates how human walk. The structure is similar to that of a human leg, including thighs, calves, and ankles, and soles. In addition, the humanoid robot also has a virtual centroid, where the virtual centroid refers to a balance point established when the humanoid robot is stationary. If a force is applied to this point, the system will move along the direction of the force without rotating.

In order to reduce the height of the virtual centroid of the humanoid robot while walking, the original planning value of the virtual centroid of the humanoid robot at the current moment can be obtained first, and the original planning value of the virtual centroid is configured to construct the humanoid robot.

It should be noted that the various initial and/or original planning values for the gait control of the humanoid robot may be obtained based on the linear inverted pendulum model LIPM, which will not be described hereinafter.

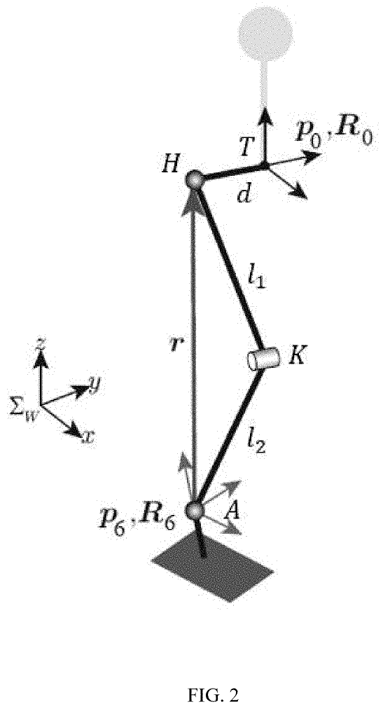

Furthermore, the first vector from the virtual centroid to the ankle joint of the left leg of the humanoid robot at the current moment and the second vector from the virtual centroid to the ankle joint of the right leg of the humanoid robot will also be obtained. FIG. 2 is a schematic view of the right leg of the humanoid robot in accordance with one embodiment of the present disclosure, wherein Σ_{W} is the world coordinate system including x, y, and z axes, the point T is the origin of body coordinates, that is, the virtual centroid point, and the point H is the hip joint, the point K is the knee joint, and the point A is the ankle joint, “d” is the distance from the virtual centroid to the hip joint, and l₁ is the length of the thigh and calf respectively.

It can be understood that the vector from the virtual centroid to the ankle joint can be obtained through positive kinematics. Taking the left leg as an example, the first vector from the virtual centroid to the ankle joint of the left leg is:

d_{L}=p₆−p₀

Wherein, p6 is the position of the ankle joint of the left leg, p0 is the position of the virtual centroid, and the second vector “dR” from the virtual centroid to the ankle joint of the right leg can be similarly obtained.

In step 102, determining a height of the target virtual centroid of the humanoid robot after the virtual centroid is reduced at the current moment according to the first vector, the second vector, the original planning value of the virtual centroid and a preset virtual centroid height reduction algorithm.

In step 103, controlling the humanoid robot to walk on straight knees according to the height of the target virtual centroid.

In the embodiment, walking with straight knees means that the humanoid robot generates a straight knee state at a certain moment when walking during the entire walking cycle, so that the torque requirement of the knee joint steering gear is reduced and the speed is increased.

In brief, the humanoid gait control method of the humanoid robot includes: obtaining a first vector from a virtual centroid to an ankle joint of a left leg of a humanoid robot at a current moment and a second vector from the virtual centroid to an ankle joint of a right leg at the current moment, and obtaining an original planning value of the virtual centroid of the current moment of the humanoid robot; determine a height of the target virtual centroid of the humanoid robot after the virtual centroid is reduced at the current moment according to the first vector, the second vector, the original planning value of the virtual centroid and a preset virtual centroid height reduction algorithm; and controlling the humanoid robot to walk on straight knees according to the height of the target virtual centroid.

By using the vector between the legs of the humanoid robot and the virtual centroid, the height of the virtual centroid of the humanoid robot is reduced. By reducing the height of the virtual centroid, the straight knee walking may be realized and the gait of the humanoid robot may be controlled. Further, the torque demand of the knee joint steering gear may be reduced, so as to realize the weight reduction of the hardware design.

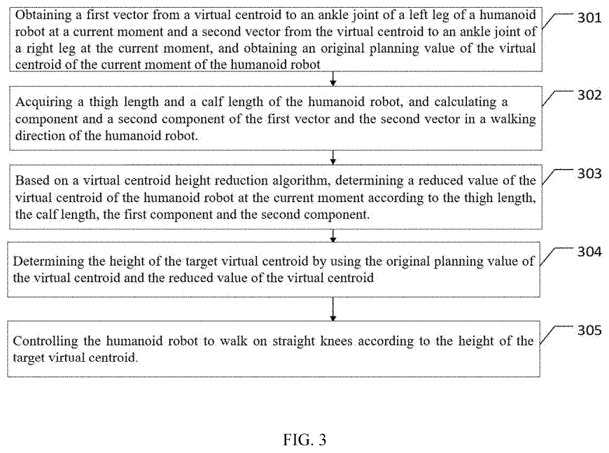

FIG. 3 is a schematic view of the right leg of the humanoid robot in accordance with another embodiment of the present disclosure. The method includes the following steps:

In step 301: obtaining a first vector from a virtual centroid to an ankle joint of a left leg of a humanoid robot at a current moment and a second vector from the virtual centroid to an ankle joint of a right leg at the current moment, and obtaining an original planning value of the virtual centroid of the current moment of the humanoid robot.

In step 302, acquiring a thigh length and a calf length of the humanoid robot, and calculating a first component and a second component of the first vector and the second vector in a walking direction of the humanoid robot.

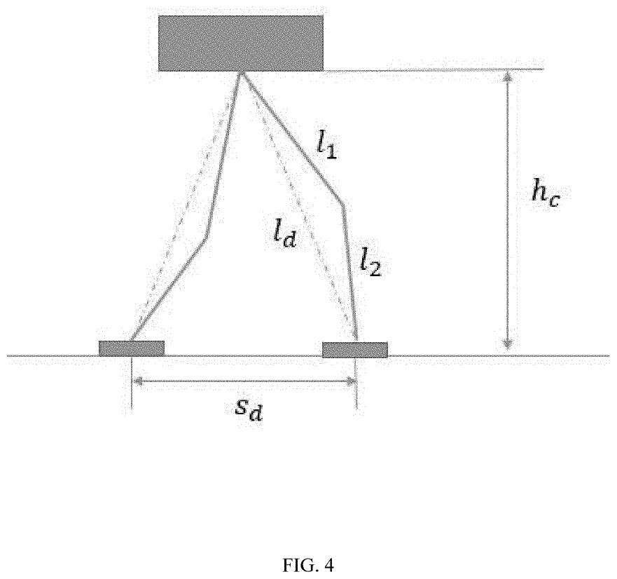

FIG. 4 is a schematic view of the walking mode of the humanoid robot in accordance with one embodiment of the present disclosure, wherein the expected leg length is the dashed line “l_{d}”, the step length is s_{d}, the center of mass height is s_{d}, in FIG. 4. The first component dLₓ and the second component dRₓ may be obtained by calculating the first vector dL and the second vector dR. This calculation process is a positive kinematics calculation process, and thus will not be described hereinafter.

In step 303, based on a virtual centroid height reduction algorithm, determining a reduced value of the virtual centroid of the humanoid robot at the current moment according to the thigh length, the calf length, the first component and the second component.

In the embodiment, it is understood that the biped robot does not need to increase the leg length at all times during the entire walking cycle, that is, reducing the height of the center of mass is not necessary for the entire walking cycle. Therefore, we propose a gait-based centroid reduction algorithm, wherein the parameters of the traditional LIPM algorithm, i.e., s_{d}, is replaced by dLₓ−dRₓ, and a new algorithm is as follows:

Δh=(l₁+l₇)−{square root over ((l₁+l₂)²−α((dLₓ−dRₓ)/2)²)};

Wherein α≥1 is the margin coefficient, and the first component dLₓ and the second component dRₓ are the components of the first vector and the second vector in the walking direction, respectively. In a left-leg forward walking cycle, the value of changes dLₓ−dRₓ from −s_{d} to s_{d}, and in a right-leg forward walking cycle, the value of changes dRₓdLₓ from −s_{d} to s_{d}, that is, the above difference calculation can be understood as the change in the distance between the legs, and the difference between the swing leg and the support leg component is obtained.

It should be noted that the traditional gait planning model is a Linear Inverted Pendulum Mode (hereinafter referred to as LIPM), which keeps the height of the center of mass unchanged, and increases the step length when the walking speed is increased. Therefore, according to Pythagorean theorem, the expected leg length, i.e., l_{d}, of LIPM can be reduced by reducing the height of the center of mass, i.e., h_{c}. The specific calculation formula for lowering the height of the center of mass, i.e., Δh is:

Δh=(l₁+l₂)−\sqrt{(l₁+l₂)²−α(s_{d}/2)²};

wherein α≥1 is the margin coefficient, and the height of centroid is h_{c}=l₁+l₂−Δh.

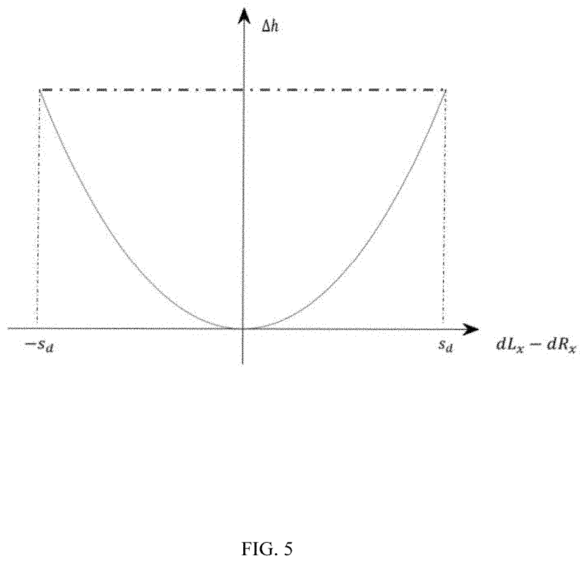

FIG. 5 is a schematic view of a comparison between the height change of the centroid in the embodiment of the present disclosure and the traditional LIMP centroid.

It should be noted that the curve shown in FIG. 5 is the height change of the center of mass of the straight knee walking mode, and the straight line formed by the dot-dash line is the height change of the center of mass of the LIPM model, where the abscissa is the distance between the legs in the walking direction, and the distance is the difference between the swing leg and the support leg when walking with straight knees, and the ordinate is the height change of the center of mass.

It can be understood that the distance between the legs in the walking direction may be, but not limited to, “−sd˜sd”, or “−sd1˜sd2”.

In step 304, determining the height of the target virtual centroid by using the original planning value of the virtual centroid and the reduced value of the virtual centroid;

It can be understood that the target virtual centroid may be calculated by the formula below:

h_{c}=l₁+l₂−Δh;

Wherein Δh is obtained by the virtual centroid height reduction algorithm, such that the height of the center of mass is related to the distance between the legs at the current moment, and the height of the center of mass is accurately controlled.

In step 305, controlling the humanoid robot to walk on straight knees according to the height of the target virtual centroid.

In the embodiment, step 305 is similar to step 103, and thus the description will be omitted hereinafter.

In the embodiment, the method further includes steps 304 a-d, which are executed before the step 305.

In step 304a, determining a target period that the humanoid robot is in during the straight-knee walking cycle at the current moment, where the target period is a double-leg support period or a single-leg support period;

It should be noted that the legs of the humanoid robot are similar to the changes in the legs during human walking. The leg state includes the two-leg support period and the single-leg support period. The two-leg support period is the standing state of the humanoid robot. The single-leg support period is the period of that legs alternates during travel.

In step 304b, determining a support leg and a swing leg of the humanoid robot when the target stage is the single-leg support period;

It is understandable that the supporting leg and swinging leg will be defined during the single-leg support period, and the relative positional relationship between the ankles of the legs and the virtual centroid in the walking direction is calculated in real time through inverse kinematics. If the positional relationship changes means it is a swinging leg.

In step 304c, determining the swinging stage of the swinging leg at the current moment, the swinging stage including swinging-leg-raising stage, swinging-leg-floating stage, and swinging-leg-landing stage.

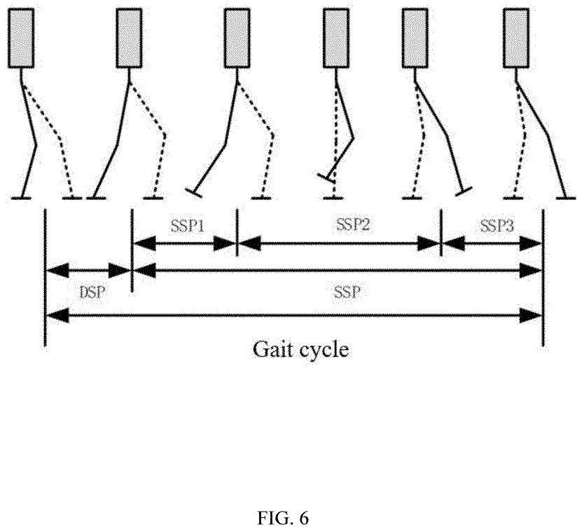

FIG. 6 is a schematic view showing the gait cycle division of the humanoid gait control method of the humanoid robots in accordance with one embodiment of the present disclosure.

As shown in FIG. 6, assuming that the right leg supports and the left leg swings, the walking cycle of the entire straight knee of the humanoid robot is divided into a single-leg support period, which can be expressed as SSP, and a double-leg support period, which can be expressed as DSP. Further, considering that there is a change in the pitch angle of the foot floor during the single-leg support period, SSP can be divided into swing leg raising stage (SSP1), swing leg emptying stage (SSP2), and the swing leg landing stage (SSP3).

In the embodiment, the gait cycle is divided based on the change in the position of the center of mass, that is, the distance between the legs. Taking a left-leg forward walking cycle as an example, the value of changes dLₓ−dRₓ from −s_{d} to s_{d}, and the preset coefficients λ are respectively, and the preset step length-1<λ₁<λ₂<λ₃<λ₄<1.

When dLₓ=λ₁*s_{d}, enter the SSP1 stage, swing the ankle of the leg around the toe;

When dLₓ=λ₂*s_{d}, the pitch angle increases to θₘₐₓ, entering the SSP2 stage;

When dLₓ=λ₃*s_{d}, the pitch angle is reduced to θₘᵢₙ, entering the SSP3 stage;

When dLₓ=λ₄*s_{d}, the pitch angle returns to 0, entering the next DSP stage.

In the same way, in a right-leg forward walking cycle, the dLₓ is replaced by dRₓ, dLₓ−dRₓ indicates the distance between the swing leg and the support leg. When the robot is walking, the position of the swinging leg in the walking direction will change the distance between the legs in the walking direction.

In the above embodiment, the step 304c includes:

Obtaining a target component in the walking direction from the virtual centroid to the swing leg at the current moment;

When a ratio of the target component to the preset step length is greater than or equal to a preset first coefficient and less than a preset second coefficient, it is determined that the swinging stage at the current moment is the swing-leg-raising stage;

When the ratio of the target component to the preset step length is greater than or equal to a preset second coefficient and less than a preset third coefficient, it is determined that the swinging stage at the current moment is the swing-leg-floating stage;

When the ratio of the target component to the preset step length is greater than or equal to the preset third coefficient and less than a preset fourth coefficient, it is determined that the swinging stage at the current moment is the swing-leg-landing stage;

Wherein the first coefficient, the second coefficient, the third coefficient, and the fourth coefficient increase sequentially, and are all greater than −1 and less than 1.

It is to be noted that the pitch angle is one of the foot attitude angles, and the foot attitude angle includes a roll angle, a yaw angle, and a pitch angle. Among them, the projection point of the ankle on the horizontal plane is used as the coordinate origin to establish the foot body coordinate system xyz, where the x axis is parallel to the horizontal plane and the walking direction is the positive direction of the x axis, the y axis is perpendicular to the x axis and parallel to the horizontal plane. The z axis is perpendicular to the x-axis and perpendicular to the horizontal plane, and the x-axis, y-axis and z-axis are orthogonal to each other. The angle between the projection of the sole on the yz plane and the horizontal plane is called as the rolling angle, and the angle between the projection of the sole on the xz plane and the horizontal plane is called as the pitch angle, the angle between the projection of the sole on the xy plane and the horizontal plane is called as the yaw angle. In the embodiment of the present disclosure, the final foot attitude angle is planned by planning the pitch angle.

In step 304d, determining the target pitch angle of the swing leg according to the swing stage of the swing leg at the current moment;

In an embodiment, the step 304d includes:

If the swinging stage of the swinging leg at the current moment is the swinging-leg-raising stage, the ratio and the preset first pitch angle algorithm are adopted to determine the target pitch angle of the swinging leg, wherein the first pitch angle algorithm is the first algorithm in which the pitch angle increases with the coefficient;

If the swing stage of the swing leg at the current moment is the swing-leg-floating stage, then the ratio and the preset second pitch angle algorithm are adopted to determine the target pitch angle of the swing leg, wherein the preset second pitch angle algorithm is the second algorithm in which the pitch angle decreases with the preset coefficient;

If the swing stage of the swing leg at the current moment is the swing-leg-landing stage, the ratio and the preset third pitch angle algorithm are adopted to determine the target pitch angle of the swing leg, wherein the preset third pitch angle algorithm is the third algorithm in which the pitch angle increases with the coefficient.

It can be understood that in the SSP1 stage, the swing leg ankle rotates around the toe, the pitch angle increases from 0 to a maximum value θₘₐₓ, and then the swing leg is off the ground, it enters the SSP2 stage;

In the SSP2 stage, the swing leg vacates, during which the pitch angle decrease from θₘₐₓ to θₘᵢₙ, and then the swing leg heel touches the ground and enters the SSP3 stage;

In the SSP3 stage, the swing leg ankle rotates around the heel, the pitch angle θ returns from θₘᵢₙ to 0, and then enters the DSP stage. The SSP stage and the DSP stage alternate to form a bipedal walking cycle.

It is to be noted that in the SSP1 stage (λ₁s_{d}˜λ₂s_{d}), the first algorithm is:

θ=f(0,θₘₐₓ,0,0,λ₂s_{d}−λ₁s_{d},dLₓ(dRₓ);

In the SSP2 stage (λ₂s_{d}˜λ₃s_{d}), the second algorithm is:

θ=f(θₘₐₓ,θₘᵢₙ,0,0,λ₃s_{d}−λ₂s_{d},dLₓ(dRₓ));

In the SSP3 stage (λ₃s_{d}˜λ₄s_{d}), the third algorithm is:

θ=f(θₘᵢₙ,0,0,0,λ₄s_{d}−λ₃s_{d},dLₓ(dRₓ));

It is to be noted that in the DSP stage (other state), θ≡0.

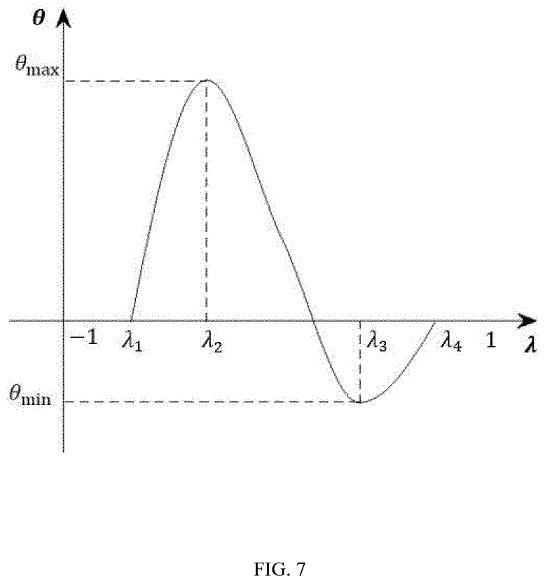

FIG. 7 is a schematic view of the pitch angle of the foot of the humanoid robot changing with the preset coefficient in accordance with one embodiment of the present disclosure.

It is understandable that, in order not to affect the balance of the swinging leg's touch-to-ground switching and the foot-lifting switch, the planning of the pitch angle needs to use an interpolation algorithm. In the example below, a cubic polynomial curve is adopted to introduce the interpolation algorithm. The smooth motion curve meets the following constraints:

The initial position at the initial time t₀ (usually 0) is x₀ and v₀, and the desired position at the end time t_{f} is x₁ and v₁. The following uses a cubic polynomial curve as an example to introduce the interpolation algorithm. The motion curve is:

x(t)=f(x₀,x₁,v₀,v₁,t_{f},t)=a₀+a₁t+a₂t²+a₃t³;

The coefficients of the cubic polynomial function satisfying the above constraint are:

$${a}_{0} = {x}_{0} ;$$

$${a}_{1} = {v}_{1} ;$$

$${a}_{2} = \frac{3}{{t}_{f}^{2}} ( {x}_{1} - {x}_{0} ) - \frac{2}{{t}_{f}} {v}_{0} - \frac{1}{{t}_{f}} {v}_{1} ;$$

$${a}_{3} = \frac{2}{{t}_{f}^{3}} ( {x}_{1} - {x}_{0} ) - \frac{1}{{t}_{f}} ( {v}_{0} + {v}_{1} ) .$$

It can be understood that the aforementioned interpolation algorithm may also be a cubic polynomial curve, a S-curve, a cubic spline curve, a cubic Hermite curve, a Bezier curve, etc., which are only examples and not specifically limited.

It should be noted that after the processing of steps 304a-d, the step 305 includes:

According to the height of the target virtual centroid, the humanoid robot is controlled to walk on straight knees, and at the same time, the soles of the swinging legs are controlled to flip according to the target pitch angle.

It should be noted that, while controlling the humanoid robot to walk on straight knees and the flipping of the soles of the swinging legs simultaneously, the speed can be further increased.

In the embodiment, the step 305 further includes:

Step 305i, determining a position vector from the ankle of the swing leg to the support point at the current moment according to the target pitch angle;

It should be noted that the position vector is a directed line segment with the coordinate origin as the starting point and the position of the moving mass point as the end point at a certain moment. In the embodiment of the present disclosure, the position vector is the position vector from the ankle to the support point. When the support point changes, the position vector changes.

It is to be noted that the step 305i further includes:

If the target pitch angle is greater than zero, it is determined that the position vector from the ankle to the support point of the swing leg at the current moment is a first position vector, and the first position vector is the distance from the ankle to the toe of the swing leg;

If the target pitch angle is equal to zero, it is determined that the position vector from the ankle to the support point of the swing leg at the current moment is the second position vector, and the second position vector is the projection of the ankle to the sole surface of the swing leg;

If the target pitch angle is less than zero, it is determined that the position vector from the ankle to the support point of the swing leg at the current moment is the third position vector, and the third position vector is the ankle to the heal of the swing leg.

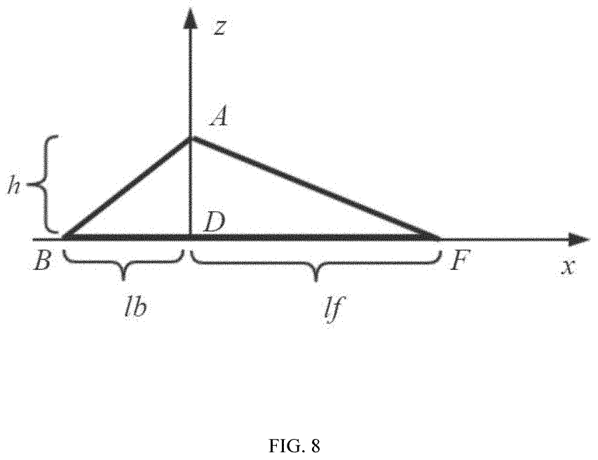

FIG. 8 is a schematic view of the foot parameters of the humanoid gait control method of humanoid robots in accordance with one embodiment of the present disclosure.

The point A represents the ankle, and the point D represents the projection of the ankle on the ground; the point F represents the toe, and the point B dot represents the heel. Assuming the height of the ankle AD=h, the front half of the foot FD=lf, and the back half BD=lb.

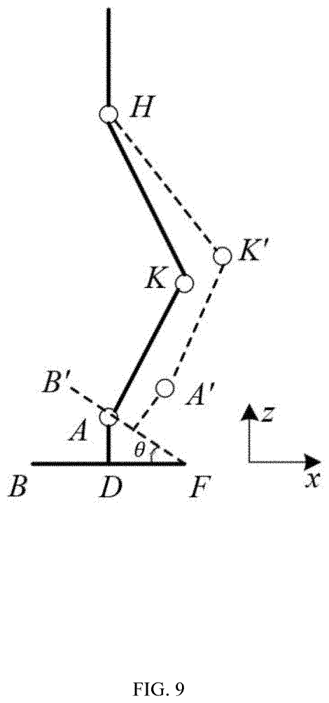

FIG. 9 is a schematic view illustrating the relationship between the ankle position changes caused by changes in the pitch angle of the soles of the swinging legs of the humanoid gait control method of humanoid robots in accordance with one embodiment of the present disclosure, wherein point H represent hip joints, point K and K′ represent knee joint positions before and after the change, and point A and A′ represent the ankle joint positions before and after the change, point F represent the toes, and point B and B′ represent the heel positions before and after the change.

In the embodiment, the change in the pitch angle of the foot sole at the SSP2 and SSP3 stages is similar to the above process. When the pitch angle changes, the support point will change, so as to determine the support points at different stages, as shown in FIG. 9. As shown, set the origin of the coordinate system as the D point, and establish a foot body coordinate system. In the foot body coordinate system, the position vector from the ankle to the support point is (ll,hh)^{T}, where “ll” is the x-axis component of the position vector from the ankle to the support point, “hh” is the z-axis component of the position vector from the ankle to the support point, and T is the transpose symbol.

The support point is determined by the pitch (θ) change of the foot's pitch angle, and the above-mentioned position vector can be further determined. It is understandable that the change of the pitch angle will not cause the y-axis to change, so the y direction is not considered.

Wherein, when θ>0, toe support, ll=lf, the first position vector is (lf,−h)^{T}.

When θ=0, the sole surface of the foot is the support point, ll=0, the second position vector is (0,−h)^{T};

When θ<0, the heel is the support point, ll=−lb, the third position vector is (−lb,−h)^{T}.

It can be understood that in the foot body coordinate system, the ankle is always in the z direction position vector with the coordinate origin, and when the support point changes, the position of the support point and the coordinate origin in the x direction will change and cause the above-mentioned change of “ll”.

Step 305ii, according to the position vector and the target pitch angle, determining the corrected target desired angle of the ankle of the swinging leg at the current moment, and the corrected target desired angle is the ankle joint rotation angle;

It is to be noted that the step 305ii includes:

adopting the preset initial planning value of the ankle position of the swing leg at the current moment, the target pitch angle, and the position vector to determine the target position of the ankle of the swing leg at the current moment by a preset ankle position calculation method;

acquiring the desired angle of the ankle at the target position at the current moment;

adopting the desired angle and the target pitch angle to determine the corrected target desired angle at the current moment.

It should be noted that the initial planning value of the ankle position at the current moment of the swinging leg is preset during the construction of the humanoid robot model. In order to realize the walking control of the humanoid robot, the preset initial planning value needs to be changed. The target pitch angle and position vector calculated in the above steps are substituted into the preset ankle position calculation method to determine the final ankle position, that is, the target position.

Wherein, the amount of change in the ankle position can be determined according to the following formula:

dₐₙₖₗₑ=g(θ)=(I−R)*(ll,hh)^{T};

Wherein

$$I = [ \begin{matrix}1 & 0 \\ 0 & 1\end{matrix} ]$$

is the unit matrix;

$$R = [ \begin{matrix}cos θ & sin θ \\ - sin θ & cos θ\end{matrix} ]$$

is a rotation matrix, θ is the target pitch angle. As the y-axis change has no effect on the pitch angle, the calculation steps can be omitted.

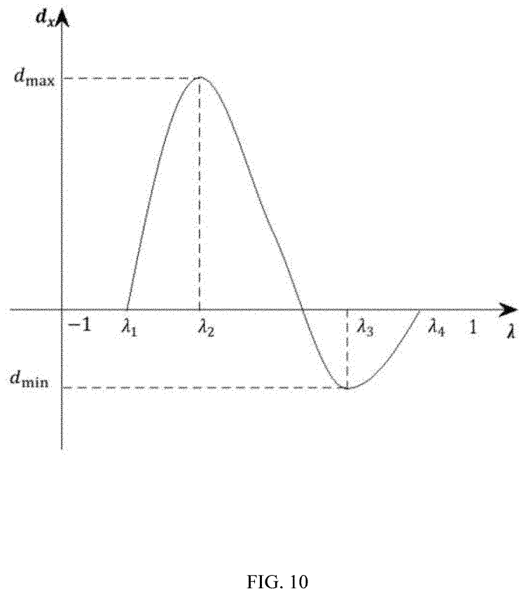

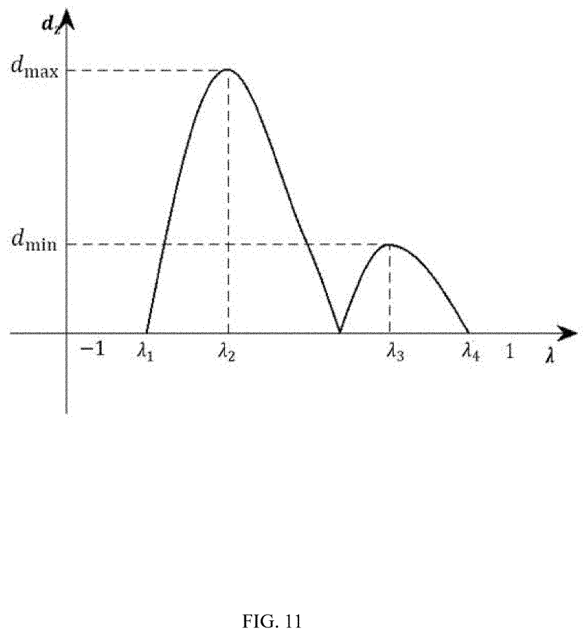

FIG. 10 is a schematic view illustrating the change of ankle position in X direction of the humanoid gait control method of humanoid robots in accordance with one embodiment of the present disclosure. FIG. 11 is a schematic view illustrating the amount of change in the ankle position in the Z direction of the humanoid gait control method of humanoid robots in accordance with one embodiment of the present disclosure.

It is to be noted that dₘₐₓ and dₘᵢₙ are not the maximum and the minimum values of dₐₙₖₗₑ. Instead, they represent the corresponding values of dₐₙₖₗₑ relating to the maximum pitch angle (θ) and the minimum pitch angle (θ).

By substituting the calculation result of the above formula into the preset ankle position calculation method, the target position of the ankle position in the walking direction can be further obtained;

Taking the swing of the left leg as an example, the preset ankle position calculation method is as follows:

left.x=x+d__{ankle.x};

left.y=y;

left.z=z+d__{ankle.z};

Among them, left.x, left.y, left.z are the target positions, x, y, and z are the initial planning values of the ankle position of the left leg at the current moment, and d__{ankle.x} is the amount of the ankle position change in the x direction. The first component, d__{ankle.z} is the second component of the ankle position change in the z direction, and the ankle position change does not affect the y-direction component.

It can be understood that the solution to the target position of the right leg is similar to that of the left leg, and will not be repeated here.

In the embodiment, after the target position is determined, inverse kinematics can be used to obtain the desired ankle angle, and the corrected target desired angle at the current moment can be determined by the following algorithm:

ql5′=ql5+θ;

Wherein, ql5′ is the corrected target desired angle at the current moment, “ql5” is the desired angle at the current moment, and θ is the pitch angle at the current moment.

Step 305iii, flipping the sole according to the corrected target desired angle.

In the embodiment, the above-mentioned corrected target desired angle is fed back to the servo mechanism to flip the ankle joint.

In the humanoid gait control method of the humanoid robot in the embodiments, the height of the virtual centroid of the humanoid robot is reduced by the vector between the legs and the virtual centroid, and the height of the humanoid robot is reduced by the pitch of the sole. In addition, via angle planning and ankle joint planning, simultaneous control of two gait planning algorithms through straight knee walking and sole flipping may be realized, which increases leg length and achieves larger step lengths to increase movement speed; on the other hand, walking on straight knees reduces the height of the center of mass reduction of the traditional LIPM algorithm, reduces the torque requirements of the steering gear of the knee joint, and realizes the reduction of the hardware design weight. The center of mass reduction algorithm of straight knee walking reduces the height of the center of mass, improves the center of mass, and increases the stability of gait control compared with the linear inverted pendulum model.

In an embodiment, a humanoid gait control device for a humanoid robot is provided. The device includes a processor and a memory. The memory stores a computer program. When the processor executes the computer program, the processor performs the following steps:

Obtaining a first vector from a virtual centroid to an ankle joint of a left leg of a humanoid robot at a current moment and a second vector from the virtual centroid to an ankle joint of a right leg at the current moment, and obtaining an original planning value of the virtual centroid of the current moment of the humanoid robot;

determining a height of the target virtual centroid of the humanoid robot after the virtual centroid is reduced at the current moment according to the first vector, the second vector, the original planning value of the virtual centroid and a preset virtual centroid height reduction algorithm; and

controlling the humanoid robot to walk on straight knees according to the height of the target virtual centroid.

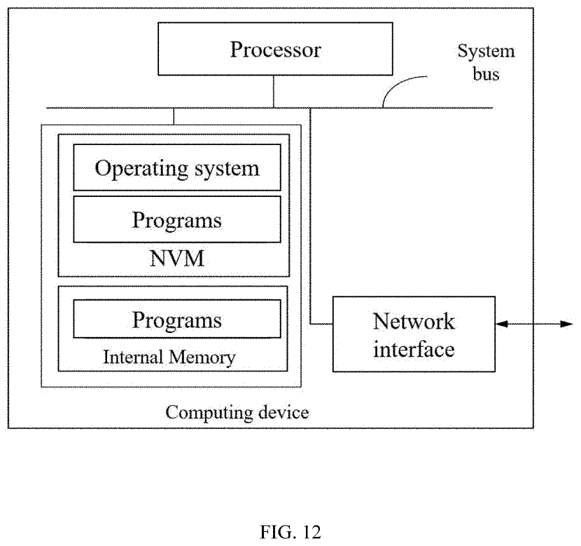

FIG. 12 is a schematic view showing the computing device in accordance with one embodiment of the present disclosure.

As shown in FIG. 12, the computing device includes a processor, a memory, and a network interface connected through a system bus. Among them, the memory includes a non-volatile storage medium and an internal memory. The non-volatile storage medium of the computing device stores an operating system, and may also store a computer program. When the computer program is executed by the processor, the processor can enable the processor to implement each step in the above method embodiment. A computer program can also be stored in the internal memory. When the computer program is executed by the processor, the processor can execute the steps in the above method embodiment. Those skilled in the art can understand that the structure shown in FIG. 12 is only a block diagram of part of the structure related to the present disclosure, and does not constitute a limitation on the computing device. The computing device may include more or fewer components than shown in the figures, or combine certain components, or have a different component arrangement.

In an embodiment, a computing device is provided, including a memory and a processor, the memory stores a computer program, and when the computer program is executed by the processor, the processor executes the following steps:

In an embodiment, a computing device is provided. The device includes a processor and a memory. The memory stores a computer program. When the processor executes the computer program, the processor performs the following steps:

Obtaining a first vector from a virtual centroid to an ankle joint of a left leg of a humanoid robot at a current moment and a second vector from the virtual centroid to an ankle joint of a right leg at the current moment, and obtaining an original planning value of the virtual centroid of the current moment of the humanoid robot;

determining a height of the target virtual centroid of the humanoid robot after the virtual centroid is reduced at the current moment according to the first vector, the second vector, the original planning value of the virtual centroid and a preset virtual centroid height reduction algorithm; and

controlling the humanoid robot to walk on straight knees according to the height of the target virtual centroid.

In an embodiment, a computer-readable storage medium is provided. The computer-readable storage medium stored with a computer program. When the processor executes the computer program, the processor performs the following steps:

Obtaining a first vector from a virtual centroid to an ankle joint of a left leg of a humanoid robot at a current moment and a second vector from the virtual centroid to an ankle joint of a right leg at the current moment, and obtaining an original planning value of the virtual centroid of the current moment of the humanoid robot;

determining a height of the target virtual centroid of the humanoid robot after the virtual centroid is reduced at the current moment according to the first vector, the second vector, the original planning value of the virtual centroid and a preset virtual centroid height reduction algorithm; and

controlling the humanoid robot to walk on straight knees according to the height of the target virtual centroid.

Those of ordinary skill in the art can understand that all or part of the processes in the above-mentioned embodiment methods can be implemented by instructing relevant hardware through a computer program. The program can be stored in a non-volatile computer readable storage. In the medium, when the program is executed, it may include the processes of the above-mentioned embodiments. Wherein, any reference to memory, storage, database or other media used in the embodiments provided in this application may include non-volatile and/or volatile memory. Non-volatile memory may include read-only memory (ROM), programmable ROM (PROM), electrically programmable ROM (EPROM), electrically erasable programmable ROM (EEPROM), or flash memory. Volatile memory may include random access memory (RAM) or external cache memory. As an illustration and not a limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), synchronous link (Synchlink) DRAM (SLDRAM), memory bus (Rambus) direct RAM (RDRAM), direct memory bus dynamic RAM (DRDRAM), and memory bus dynamic RAM (RDRAM), etc.

Embodiments are used in the present disclosure to illustrate the principle and implementation of the present disclosure. The descriptions of the forgoing embodiment are only used to help understand the technical schemes of the present disclosure and their core ideas. At the same time, for those skilled in the art, according to the ideas of the present disclosure, there will be changes in the specific implementation and the application scope. In summary, the contents of the present disclosure should not be construed as limitations to the present disclosure.

What is claimed is:

1. A humanoid gait control method of humanoid robots, comprising:
obtaining a first vector from a virtual centroid to an ankle joint of a left leg of the humanoid robot at a current moment and a second vector from the virtual centroid to an ankle joint of a right leg at the current moment, and obtaining an original planning value of the virtual centroid of the current moment of the humanoid robot;
determining a height of the target virtual centroid of the humanoid robot after the virtual centroid is reduced at the current moment according to the first vector, the second vector, the original planning value of the virtual centroid and a preset virtual centroid height reduction algorithm; and
controlling the humanoid robot to walk on straight knees according to the height of the target virtual centroid.

2. The method according to claim 1, wherein the determining step further comprises:
acquiring a thigh length and a calf length of the humanoid robot, and calculating a first component and a second component of the first vector and the second vector in a walking direction of the humanoid robot;
based on a virtual centroid height reduction algorithm, determining a reduced value of the virtual centroid of the humanoid robot at the current moment according to the thigh length, the calf length, the first component and the second component; and
determining the height of the target virtual centroid by using the original planning value of the virtual centroid and the reduced value of the virtual centroid.

3. The method according to claim 1, the method further comprises:
wherein the method further comprises steps before the controlling step:
determining a target period that the humanoid robot is in during a straight-knee walking cycle at the current moment, where the target period is a double-leg support period or a single-leg support period;
determining a support leg and a swing leg of the humanoid robot when the target stage is the single-leg support period;
determining the swinging stage of the swinging leg at the current moment, the swinging stage comprising swinging-leg-raising stage, swinging-leg-floating stage, and swinging-leg-landing stage;
determining a target pitch angle of the swing leg according to the swing stage of the swing leg at the current moment;
wherein the controlling step further comprises:
controlling the humanoid robot to walk on straight knees, and at the same time according to the height of the target virtual centroid, and controlling soles of the swinging legs to flip according to the target pitch angle.

4. The method according to claim 3, wherein the step of determining the swinging stage of the swinging leg at the current moment further comprises:
obtaining a target component in the walking direction from the virtual centroid to the swing leg at the current moment;
when a ratio of the target component to a preset step length is greater than or equal to a preset first coefficient and less than a preset second coefficient, it is determined that the swinging stage at the current moment is the swing-leg-raising stage;
when the ratio of the target component to the preset step length is greater than or equal to a preset second coefficient and less than a preset third coefficient, it is determined that the swinging stage at the current moment is the swing-leg-floating stage;
when the ratio of the target component to the preset step length is greater than or equal to the preset third coefficient and less than a preset fourth coefficient, it is determined that the swinging stage at the current moment is the swing-leg-landing stage; and
wherein the first coefficient, the second coefficient, the third coefficient, and the fourth coefficient increase sequentially, and are all greater than −1 and less than 1.

5. The method according to claim 4, wherein the step of determining a target pitch angle of the swing leg according to the swing stage of the swing leg at the current moment further comprises:
if the swinging stage of the swinging leg at the current moment is the swinging-leg-raising stage, the ratio and the preset first pitch angle algorithm are adopted to determine the target pitch angle of the swinging leg, wherein the first pitch angle algorithm is the first algorithm in which the pitch angle increases with the coefficient;
if the swing stage of the swing leg at the current moment is the swing-leg-floating stage, then the ratio and the preset second pitch angle algorithm are adopted to determine the target pitch angle of the swing leg, wherein the preset second pitch angle algorithm is the second algorithm in which the pitch angle decreases with the preset coefficient; and
if the swing stage of the swing leg at the current moment is the swing-leg-landing stage, the ratio and the preset third pitch angle algorithm are adopted to determine the target pitch angle of the swing leg, wherein the preset third pitch angle algorithm is the third algorithm in which the pitch angle increases with the coefficient.

6. The method according to claim 3, wherein the step of controlling soles of the swinging legs to flip according to the target pitch angle further comprises:
determining a position vector from the ankle of the swing leg to the support point at the current moment according to the target pitch angle;
according to the position vector and the target pitch angle, determining the corrected target desired angle of the ankle of the swinging leg at the current moment, and the corrected target desired angle is the ankle joint rotation angle; and
flipping the sole according to the corrected target desired angle.

7. The method according to claim 6, wherein the step of determining a position vector from the ankle of the swing leg to the support point at the current moment according to the target pitch angle further comprises:
if the target pitch angle is greater than zero, it is determined that the position vector from the ankle to the support point of the swing leg at the current moment is a first position vector, and the first position vector is the distance from the ankle to the toe of the swing leg;
if the target pitch angle is equal to zero, it is determined that the position vector from the ankle to the support point of the swing leg at the current moment is the second position vector, and the second position vector is the projection of the ankle to the sole surface of the swing leg; and
if the target pitch angle is less than zero, it is determined that the position vector from the ankle to the support point of the swing leg at the current moment is the third position vector, and the third position vector is the ankle to the heal of the swing leg.

8. The method according to claim 6, wherein the step of determining the corrected target desired angle of the ankle of the swinging leg at the current moment further comprises:
adopting the preset initial planning value of the ankle position of the swing leg at the current moment, the target pitch angle, and the position vector to determine the target position of the ankle of the swing leg at the current moment by a preset ankle position calculation method;
acquiring the desired angle of the ankle at the target position at the current moment; and
adopting the desired angle and the target pitch angle to determine the corrected target desired angle at the current moment.

9. A humanoid gait control device of humanoid robots, comprising:
a memory;
a processor; and
one or more computer programs stored in the memory and executable on the processor, wherein the one or more computer programs comprises:
instructions for obtaining a first vector from a virtual centroid to an ankle joint of a left leg of the humanoid robot at a current moment and a second vector from the virtual centroid to an ankle joint of a right leg at the current moment, and obtaining an original planning value of the virtual centroid of the current moment of the humanoid robot;
instructions for determining a height of the target virtual centroid of the humanoid robot after the virtual centroid is reduced at the current moment according to the first vector, the second vector, the original planning value of the virtual centroid and a preset virtual centroid height reduction algorithm; and
instructions for controlling the humanoid robot to walk on straight knees according to the height of the target virtual centroid.

10. A computer-readable storage medium, comprising:
one or more computer programs stored on the computer-readable storage medium and executable on a processor, wherein the one or more computer programs comprises:
instructions for obtaining a first vector from a virtual centroid to an ankle joint of a left leg of the humanoid robot at a current moment and a second vector from the virtual centroid to an ankle joint of a right leg at the current moment, and obtaining an original planning value of the virtual centroid of the current moment of the humanoid robot;
instructions for determining a height of the target virtual centroid of the humanoid robot after the virtual centroid is reduced at the current moment according to the first vector, the second vector, the original planning value of the virtual centroid and a preset virtual centroid height reduction algorithm; and
instructions for controlling the humanoid robot to walk on straight knees according to the height of the target virtual centroid.
